(19) United States
(12) Patent Application Publication
(10) Pub. No.: US 2020/0019535 A1
(43) Pub. Date: Jan. 16, 2020

(54) METHOD AND SYSTEM FOR PREPARING DATA FILES FOR TRANSMISSION OVER A DATA NETWORK

(71) Applicant: PacByte Solutions Pty Ltd, North Epping (AU)

(72) Inventor: Bruce Parker, Mt. Colah (AU)

(21) Appl. No.: 16/338,990

(22) PCT Filed: Oct. 3, 2016
(86) PCT No.: PCT/IB2016/055896

§ 371 Date: Apr. 2, 2019

(51) Int. Cl. G06F 16/17; G06F 16/11; G06F 16/16; G06F 16/182; G06F 16/176

(52) U.S. Cl. CPC G06F 16/1727; G06F 16/122; G06F 16/176; G06F 16/1824; G06F 16/16

(57) ABSTRACT

A method of processing or modifying individual data files for transmission over a data network, the method executed by a processor of an electronic device. The method includes retrieving, receiving, or accessing the individual data files to be transmitted, and processing the individual data files to determine the size of each individual data file. The individual data file sizes are then compared to a predetermined or calculated optimal data file size for transmission to identify non-optimally sized data files. The one or more identified non-optimally sized individual data files are then modified to generate modified individual data file sizes that match approximately the optimal data file size by selectively combining or merging individual data files that are smaller than the optimal data file size into a larger data file that is closer to the optimal data file size, or splitting or segmenting individual data files that are larger than the optimal data file size into smaller data files that are closer to the optimal data file size. The modified individual data files are output ready for transmission by the electronic device.

### FIELD OF THE INVENTION

This invention relates to a method and system for preparing a data file or files for transmission over a data network. In particular, although not exclusively, the method and system relates to preparing audio and/or video data files for streaming to an electronic device over a data network.

### BACKGROUND TO THE INVENTION

Data files are transmitted over the internet or other data networks, or they are stored on local or remote devices.

Bulk small data files like PDF, TIF or Video Streaming TS data files with a low bitrate, are currently delivered data file by data file, and due to this structure use additional network resources, which slows down the transfer of these data files from a network or data server over a data network to a client or user electronic device.

Conversely, mid to large size data files like high bitrate Video Streaming TS data files, H264 video data files, and “large data” files saturate network connections. This in a different way slows down the transfer of these data files from a network or data server over a data network to a client or user electronic device.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY OF THE INVENTION

It is the object of this invention to provide an improved method and system for preparing small, medium and/or large data files for delivery or transmission over a data network, or to at least provide the public with a useful choice.

In a first aspect, the invention broadly consists in a method of processing or modifying individual data files for transmission over a data network, the method executed by a processor of an electronic device, the method comprising: retrieving, receiving, or accessing the individual data files to be transmitted; processing the individual data files to determine the size of each individual data file; comparing the individual data file sizes to a predetermined or calculated optimal data file size for transmission to identify non-optimally sized data files; modifying one or more of the identified non-optimally sized individual data files based on the size comparison to generate modified individual data file sizes that match approximately the optimal data file size by selectively: combining or merging individual data files that are smaller than the optimal data file size into a larger data file that is closer to the optimal data file size, or splitting or segmenting individual data files that are larger than the optimal data file size into smaller data files that are closer to the optimal data file size; and outputting the modified individual data files ready for transmission by the electronic device.

In an embodiment, the method may further comprise identifying the file structure associated with the individual data files.

In an embodiment, identifying the file structure of the individual data files may comprise identifying the individual data files as being individual data files that form part of a data file package or batch for transmission, or identifying the individual data files as being contained within a single consolidated data file.

In an embodiment, the processing of the individual data files to determine the size of each individual data file may be based on the identified file structure of the individual data files.

In an embodiment, the individual data files may form part of a data file package or batch for transmission.

In an embodiment, the individual data files may be contained within a single consolidated data file.

In an embodiment, processing the individual data files to determine each individual data file size may comprise identifying the individual data file offsets within the single consolidated data file.

In an embodiment, comparing the individual data file sizes to the optimal data file size may comprise determining if the individual data file is larger, smaller, or approximately the same as the optimal data file size.

In an embodiment, the method may comprise designating an individual data file as being larger than the optimal data file size if is greater than a predetermined threshold above the optimal data file size.

In an embodiment, the method may comprise designating an individual data file as being smaller than the optimal data file size if it is smaller than a predetermined threshold below the optimal data file size.

In an embodiment, the method may comprise designating an individual data file as being the same as the optimal data file size if its size falls within a predetermined range centered about or relative to the optimal data file size.

In an embodiment, when individual data files are split or segmented into smaller data files the method may further comprise creating or generating an index file for transmission with the data files that records or stores the relationship of the segmented or split individual data files to enable re-assembly or re-combining back into the original data files after transmission.

In an embodiment, the method may comprise leaving any individual data files that are the same as the optimal data file size unmodified.

In an embodiment, the method may comprise modifying all identified non-optimally sized data files.

In an embodiment, the individual data files for processing may be uniform in size.

In an embodiment, at least some of the individual data files for processing may be non-uniform in size.

In an embodiment, the method may further comprise determining or calculating an optimal data file size for transmission over the data network.

In an embodiment, determining or calculating the optimal data file size may be based on data representing any one or more of the following: data network capacity, data network speed, protocol of transmission, performance characteristics of transmitting and/or receiving electronic device, and/or specifications or characteristics of one or more of the hardware devices in the intended transmission path.

In an embodiment, the optimal data file size for transmission may be a value selected or derived from the function 2ⁿ kilobytes, where n is an integer value greater than or equal to eight. For example, the optimal data file size may be selected from the group including, but not limited to, 256 kB, 512 kB, 1024 kB (1 MB), 2048 kB (2 MB), 4096 kB (4 MB), and so on.

In an embodiment, the method may further comprise selecting the integer value of n based on or as a function of data representing any one or more of the following: data network capacity, data network speed, protocol of transmission, performance characteristics of transmitting and/or receiving electronic device, and/or specifications or characteristics of one or more of the hardware devices in the intended transmission path.

In an embodiment, the electronic device may be a data or network server.

In an embodiment, the electronic device may be any one of the following: personal computer, tablet, smart phone, smart television, tablet, or wearable electronic device.

In an embodiment, the method may further comprise streaming the processed individual data files over the data network in a single thread, or a plurality or multiple threads.

In an embodiment, the data files may be audio or video data files for streaming.

In a second aspect, the invention broadly consists in an electronic device for transmitting data files over a data network, the electronic device comprising: a processor; and memory; and wherein the processor is configured to execute the method of the first aspect of the invention.

In a third aspect, the invention broadly consists in a computer-readable medium having stored thereon computer executable instructions that, when executed on a processing device or devices, cause the processing device or devices to perform a method of the first aspect of the invention.

Each aspect of the invention above may have any one or more of the features mentioned in respect of the other aspects of the invention above.

Definitions or Terms or Phrases

The term ‘comprising’ as used in this specification and claims means “consisting at least in part of”. When interpreting each statement in this specification and claims that includes the term ‘comprising’, features other than that or those prefaced by the term may also be present. Related terms such as ‘comprise’ and ‘comprises’ are to be interpreted in the same manner.

The phrase ‘computer-readable medium’ should be taken to include a single medium or multiple media. Examples of multiple media include a centralised or distributed database and/or associated caches. These multiple media store the one or more sets of computer executable instructions. The phrase ‘computer readable medium’ should also be taken to include any medium that is capable of storing, encoding or carrying a set of instructions for execution by a processor of a computing device and that cause the processor to perform any one or more of the methods described herein. The computer-readable medium is also capable of storing, encoding or carrying data structures used by or associated with these sets of instructions. The phrase ‘computer-readable medium’ includes solid-state memories, optical media and magnetic media.

Number Ranges

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “and/or” means “and” or “or”, or both.

As used herein “(s)” following a noun means the plural and/or singular forms of the noun.

The invention consists in the foregoing and also envisages constructions of which the following gives examples only.

### BRIEF DESCRIPTION OF THE DRAWINGS

Preferred embodiments of the invention will be described by way of example only and with reference to the drawings, in which:

FIG. 1 is a schematic diagram of an overview of an example system configuration of in accordance with an embodiment of the invention; and

FIG. 2 is a flow diagram showing an example of the main process steps for preparing a data file or data files for transmission over a data network in accordance with an embodiment of the invention.

### DETAILED DESCRIPTION OF PREFERRED EMBODIMENTS

In the following description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Aspects of the systems and methods described below may be operable on any type of general purpose computer system or computing device, including, but not limited to, a desktop, laptop, notebook, tablet, smart television, or mobile device. The term “mobile device” includes, but is not limited to, a wireless device, a mobile phone, a smart phone, a mobile communication device, a user communication device, personal digital assistant, mobile hand-held computer, a laptop computer, wearable electronic devices such as smart watches and head-mounted devices, an electronic book reader and reading devices capable of reading electronic contents and/or other types of mobile devices typically carried by individuals and/or having some form of communication capabilities (e.g., wireless, infrared, short-range radio, cellular etc.).

1. Overview of System Configuration and Method Process

The system and method is configured to prepare or transform a data file or files for transmission across a data network between from one device or system to another. In one configuration, the system and method may be performed on a data server that is configured to transmit or stream data files to remote client or user electronic devices. In another configuration the system and method may be performed on a client or user electronic device that is configured or operable to transmit or upload data files to a data server for storage or to another client or user device in a peer-to-peer network file sharing configuration. It will be appreciated that the system and method may be performed on any electronic device or system that is operable to send, transmit, or stream data files to another device or system over a data network, or which is used for data storage.

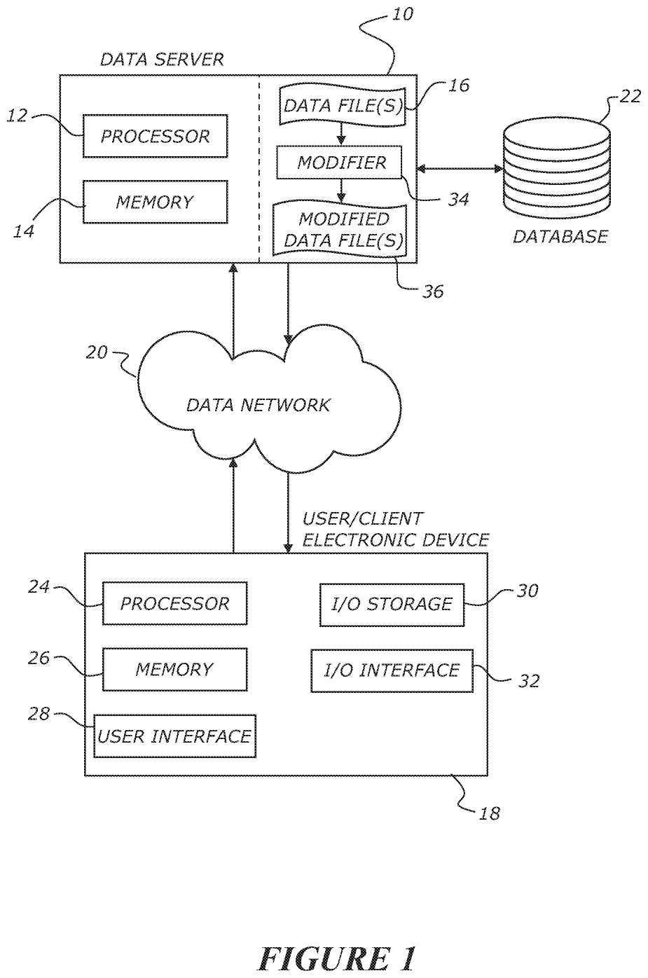

Referring to FIG. 1, an example configuration of the system and method operating in a data server 10 will be explained, although it will be appreciated that the same principles of operation apply to the transmission of data from any electronic device including the configurations mentioned above. The data server 10 may typically comprise a processor 12 and memory 14, and is configured to stream or transmit data files 16 to a client or user electronic device 18 over a data network 20 via one or more data streams or threads, either at the request of the user device or the data server may actively push the data files to the user device without request. The data server 10 may be operatively connected to or in data communication with a database 22 comprising data files that the user device may browse and select for download or streaming.

The data network 20 may typically be the internet for example, but may also be another data or communication network or combination of networks that form a data communication link, including intranets, extranets, cellular data networks such as 3G and 4G, direct wireless connections such as WiFi, Bluetooth, infrared, Near-field communication (NFC), or any other single or combination of wired and/or wireless data communication links or networks.

The user electronic device 18 may be any form of programmable electronic device such as, but not limited to, a computer, tablet, smart phone, smart television, or the like. The user electronic device 10 typically comprises hardware components such as, but not limited to, a processor 24, memory 26, user interface 28, input/output (I/O) storage component 30, and I/O interface 32. By way of example, the processor 24 may be any form of a CPU, microprocessor, microcontroller, Field Programmable Gate Array (FPGA), Application Specific Integrated Circuit (ASIC) or the like. The memory 26 typically comprises Random Access Memory (RAM) and/or memory onboard the processor. The I/O storage component 30 may, for example, comprise any one or more of a Hard Disk Drive (HDD), Solid State Drive (SSD), or Flash drive. The I/O interface 32 may typically comprises any one or more components for enabling the device to connect or communicate with other devices or data networks, such as a communications module or module, wireless connection modules for cellular data connections such as 3G or 4G, WiFi, Bluetooth, NFC or the like, wired ports or connectors such as USB ports, Ethernet ports, parallel and serial ports. The user interface 28 may vary depending on the user electronic device 18, but comprises devices or components that enable the user to interact, operate or control the user device, and may typically comprise any one or more of a display or touch-screen display, keyboard, mouse, touch pad or ball, audio output and input such as speakers and microphone.

In this embodiment, the data server 10 is configured to prepare or modify the data file or files prior to transmission in order to optimize transmission efficiency across the data network 20 to the user electronic device 18. The data server 10 is provided with a modifier 34 component or module that is configured to process the data file or files and modify, if necessary, one or more of the data files to generate modified data files 36 that are optimized for data transmission. The modifier 34 may be a software application or virtual machine executing on the data server 10 for example.

In this embodiment, the modifier 34 receives or retrieves the data file or files requested for transmission and processes or analyses the size of the data file or files 16 relative to an optimal size value to identify non-optimally sized data files. The modifier is then configured to selectively combine or segment one or more of the identified non-optimally sized data files 16 to generate or transform them into modified data files 36 of or closer to an optimal size for transmission over the data network 20. By way of example, the modifier is configured to combine or merge smaller data files into a larger data file or data packet of an approximate predefined or optimal size, or segment or split larger files into smaller data files of an approximate predefined or optimal size, prior to transmission of the data files over the data network.

In some instances, all data files will be smaller data files than the optimal size and require combining into larger data files closer to the predetermined optimal size. In other instances, all the data files will be larger data files than the optimal size and require splitting into smaller data files closer to the predetermined optimal size. In other instances, the data files for transmission may comprise a mixture of any one or more of the following: smaller data files that require combining and/or larger files that require splitting and/or data files that are close to the optimal size in their original form and which can remain un-modified.

2. Example—Modifying a Video Data File for Streaming Over a Data Network

By way of example only, an embodiment of the system and method will be described in the context of streaming video files over a data network, although it will be appreciated that the system and method may be applied to any data files that are being transmitted or streamed across a data network.

Streaming of video files over a network is typically performed in a number of different ways. Common examples include, but are not limited to, the Apple® HLS and Microsoft® IIS Smooth Streaming formats. Both of these formats use multiple MP4 encoded segments of a video (TS format). These segments are usually time based. There may also be a number of differing bitrates used for each time based segment to allow for switching between bitrate qualities based on network connection speed. These individual MP4 files are then placed into one large file and access to each segment is based on the relevant offset within the larger file to download the relevant TS data file.

For a video encoded with a 720 resolution and a bitrate of 500 Kbps, the average TS data file is approximately 170 KB in size. For a 1 Mbps bitrate, the average TS data file is approximately 310 KB in size, and for a 6 Mbps bitrate the average TS data file is approximately 1.6 MB in size.

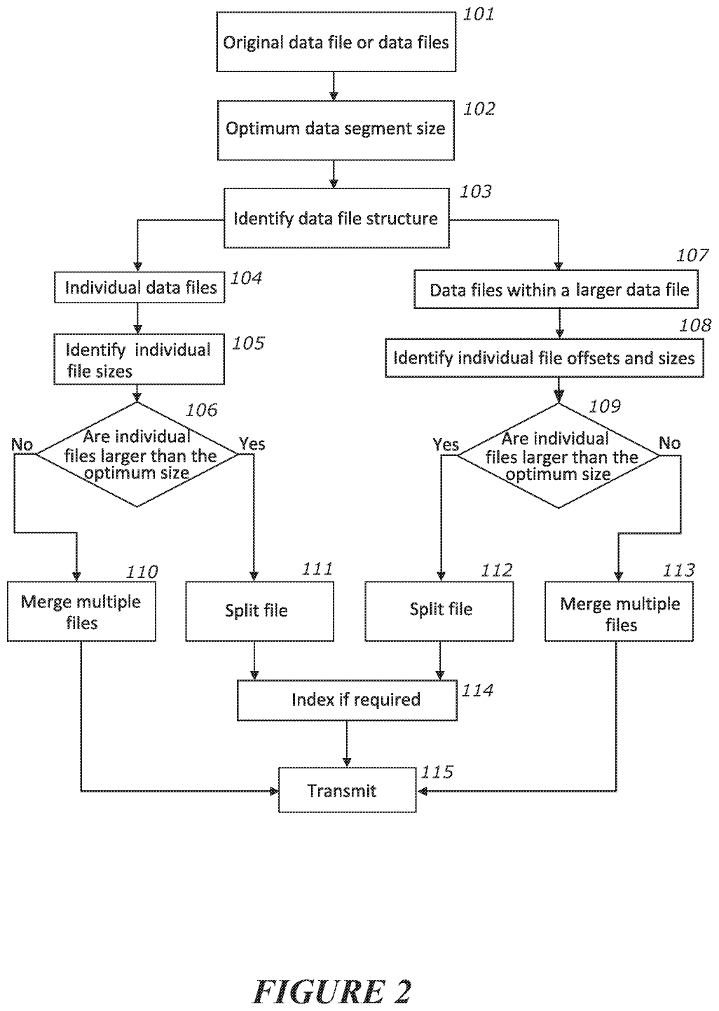

Referring to FIGS. 1 and 2, an embodiment of the system and method of preparing a video data file or files for streaming from a data server 10 across a data network 20 to a user or client electronic device 18 will be described in further detail.

Firstly, the user electronic device 18 selects or requests a segmented streaming data file or files (e.g. video data file) as shown at 101. The data server 10 retrieves those data files 16 from the database 22 or other storage. An optimal data segment size (or optimal data file size) is then either predetermined in advance or calculated at the time of streaming or download by the data server 10 as shown at 102. The optimal data segment size may be predetermined or calculated based on data representing one or more factors including, but not limited to, the data network capacity, the data network speed, the intended mode or protocol of transmission, e.g. single thread versus multi-thread, the performance characteristics of the data server and/or user electronic device, transmissions times, and/or specifications or characteristics of one or more of the hardware devices (such as, but not limited to, routers, switches or other machine-level devices) in the intended transmission path between the data server 10 and user electronic device 18 and the like.

In one embodiment, the optimal data segment or file size may be designated as a number of bytes for example. In one configuration, the optimal data file size for transmission may be a value selected or derived from the function 2ⁿ kilobytes, where n is an integer value greater than or equal to eight. For example, the optimal data file size may be selected from the group including, but not limited to, 256 kB, 512 kB, 1024 kB (1 MB), 2048 kB (2 MB), 4096 kB (4 MB), and so on. In this configuration, the system may be configured to select the integer value of n based on or as a function of data representing any one or more of the following: data network capacity, data network speed, protocol of transmission, performance characteristics of transmitting and/or receiving electronic device, and/or specifications or characteristics of one or more of the hardware devices in the intended transmission path.

By way of example, in one configuration, the optimal data file size may be calculated based on transmission times across the data network. If smaller segments or data files are transmitted faster than larger segments, then the optimal data file size may be set at say 256 kB. Alternatively, if larger segments are transmitted faster, then the optimal data file size may be set at say 4 MB.

In this embodiment, the data files are then analysed or processed by the modifier 34. Firstly, the modifier is configured to identify the data file structure of the data files to be transmitted or streamed. In a first-type of structure, the data files 16 may be individual data files, i.e. a data file package or batch comprising separate and individual data files 16 for streaming. In a second-type of structure, the individual data files 16 may be contained in a larger data file, i.e. a consolidated single data file comprising a plurality of individual data files. For example, in a consolidated singe data file, the contiguous consolidated data file may comprise offsets designating the individual files within the consolidated data file. The modifier 34 then processes the data files based on the type of data file structure identified, as explained below. The main purpose of the modifier is to modify or transform the size of identified non-optimally sized individual data files or segments to match as closely as possible the determined optimal data file size for transmission.

Data File Package or Batch of Individual Data Files

If the data file structure is identified as being a package or batch of individual data files at shown at 104, the modifier 34 then proceeds to analyse or determine the individual data file sizes at 105. The determined size of each individual data file is then compared with the optimal data segment size at 106.

If individual data files are larger than the optimal size (e.g. larger than the optimal size or larger relative to a predetermined threshold above the optimal size), then such files are split or segmented into smaller data files as shown at 111. Splitting or segmenting of such files is performed in such a way that the resulting split or segmented smaller files are as close as possible to the optimal size. If an index of the splitting or segmenting of these files is required, then an index file is created or generated prior to making the split files available for downloading or streaming as shown at 114. The index file enables re-assembly of the segmented files back into their original data files at the user electronic device after reception. In this embodiment, by way of example only, an individual data file is considered to be larger than the optimal size if it is larger than approximately 50% above the optimal size, i.e. the predetermined threshold is approximately 150% of the optimal file size.

If individual data files are smaller than the optimal size (e.g. smaller than the optimal size or smaller relative to a predetermined threshold below the optimal size), then such files are merged or combined with one or more other files into one or more larger data files as shown at 110. The merging or combing of these files is performed in such a way that the resulting larger data files are as close as possible to the optimal size. In this embodiment, by way of example only, an individual data file is considered to be smaller than the optimal size if it is smaller than approximately 25% below the optimal size, i.e. the predetermined threshold is approximately 75% of the optimal file size.

If individual files are identified as having a size that is approximately the optimal size or within a predetermined range centered about or relative to the optimal size, then such data files are neither split or merged, and are left unmodified. In this embodiment, by way of example only, the optimal file size threshold range may be between approximately 75% of the optimal file size to 150% of the optimal file size.

In some embodiments, this splitting or merging of files toward the optimal file size may be performed such that the split or merged files are preferably exactly the optimal file size, or at least within a predetermined optimal file size range, e.g. between 75% to 150% of the optimal file size range in this example.

It will be appreciated that in some scenarios the data files for transmission or streaming may typically be substantially uniform in size. In such situations, all individual data files will likely receive the same treatment, e.g. either be split, merged, or left unmodified. In other scenarios the original data files for transmission may be non-uniform in size. As such, the files may receive a mixture of treatment depending on their particular size relative to the optimal size, e.g. some may be split, others merged, and/or some may be left unmodified.

Once all the individual data files have been processed, and modified if required, the processed data files 36 are ready for transmission or streaming to the user electronic device 18 over the data network as shown at 115.

Consolidated Single Data File Comprising Individual Data Files

If the data file structure is identified as being a consolidated larger data file containing individual data files as shown at 107, the modifier 34 then proceeds to analyse or determine the individual offset address and sizes of the individual data files within the consolidated data file from the manifest or file header or equivalent as indicated at 108. The determined size of each individual data file within the consolidated file is then compared with the optimal data segment size at 109.

If individual data files held within the consolidated file are larger than the optimal size (e.g. larger than the optimal size or larger relative to a predetermined threshold above the optimal size), then such files are split or segmented into smaller data files as shown at 112. Splitting or segmenting of such files is performed in such a way that the resulting split or segmented smaller files are as close as possible to the optimal size. If an index of the splitting or segmenting of these files is required, then an index file is created or generated prior to making the split files available for downloading or streaming as shown at 114. The index file enables re-assembly of the segmented files back into their original data files at the user electronic device after reception. In this embodiment, by way of example only, an individual data file is considered to be larger than the optimal size if it is larger than approximately 50% above the optimal size, i.e. the predetermined threshold is approximately 150% of the optimal file size.

If individual data files held within the consolidated file are smaller than the optimal size (e.g. smaller than the optimal size or smaller relative to a predetermined threshold below the optimal size), then such files are merged or combined with one or more other files into one or more larger data files as shown at 113. The merging or combining of these files is performed in such a way that the resulting larger data files are as close as possible to the optimal size. In this embodiment, by way of example only, an individual data file is considered to be smaller than the optimal size if it is smaller than approximately 25% below the optimal size, i.e. the predetermined threshold is approximately 75% of the optimal file size.

If individual files held within the consolidated file are identified as having a size that is approximately the optimal size or within a predetermined range centered about or relative to the optimal size, then such data files are neither split or merged, and are left unmodified within the consolidated file. In this embodiment, by way of example only, the optimal file size threshold range may be between approximately 75% of the optimal file size to 150% of the optimal file size.

In some embodiments, this splitting or merging of files toward the optimal file size may be performed such that the split or merged files are preferably exactly the optimal file size, or at least within a predetermined optimal file size range, e.g. between 75% to 150% of the optimal file size range in this example.

It will be appreciated that in some scenarios the individual data files in the consolidated file for transmission or streaming may typically be substantially uniform in size. In such situations, all individual data files will likely receive the same processing or treatment, e.g. either be split, merged, or left unmodified within the consolidated file. In other scenarios the original data files within the consolidated file for transmission may be non-uniform in size. As such, the files may receive a mixture of processing or treatment depending on their particular size relative to the optimal size, e.g. some may be split, others merged, and/or some may be left unmodified within the consolidated file.

Once all the individual data files held within the consolidated file have been processed, and modified if required, the processed consolidated data file 36 is ready for transmission or streaming to the user electronic device 18 over the data network as shown at 115.

Transmission

In this embodiment, the data server 10 is configured to transmit the processed data file or files at 115 to the user electronic device 18 over the data network 20. Any suitable data transmission protocol or method may be used. Typically the modified individual data files, now at approximately the optimal data file size, are further segmented into data packets for transmission or streaming over the data network.

In this embodiment, the user electronic device 18 may be configured to re-order or re-assemble the received individual data files (which may now be merged or split) based on the network request time that the user electronic device requested the individual data files or segments to be transmitted.

The user electronic device may then receive the transmitted or streamed data files over a single thread or over a plurality or multiple threads, and re-assemble on the user electronic device for use, access, viewing, playback, storage or the like, depending on the nature of the data file and its contents. In this example, a video data file is streamed from the data server 10 to the user device 18, and the user device may begin playback of the video data file once sufficient data has arrived into a playback buffer.

3. Alterative applications

The above examples of the system and method are primarily directed at modifying data files for transmission from a data server to a user device. However, it will be appreciated that the system and method may also be deployed on user devices, which may be operated to upload, transmit or stream data files to a server or other electronic device (e.g. in a peer-to-peer file sharing network). In particular, the system may be used to process data files, and modify the size of those data files using splitting and combining as discussed, to enhance the size of the data files prior to transmission or streaming from the user device across the data network to another device or server.

4. General

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the foregoing, a storage medium may represent one or more devices for storing data, including read-only memory (ROM), random access memory (RAM), magnetic disk storage mediums, optical storage mediums, flash memory devices and/or other machine readable mediums for storing information. The terms “machine readable medium” and “computer readable medium” include, but are not limited to portable or fixed storage devices, optical storage devices, and/or various other mediums capable of storing, containing or carrying instruction(s) and/or data.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated the figures may be rearranged and/or combined into a single component or embodied in several components without departing from the invention. Additional elements or components may also be added without departing from the invention. Additionally, the features described herein may be implemented in software, hardware, as a business method, and/or combination thereof.

In its various aspects, the invention can be embodied in a computer-implemented process, a machine (such as an electronic device, or a general purpose computer or other device that provides a platform on which computer programs can be executed), processes performed by these machines, or an article of manufacture. Such articles can include a computer program product or digital information product in which a computer readable storage medium containing computer program instructions or computer readable data stored thereon, and processes and machines that create and use these articles of manufacture.

The foregoing description of the invention includes preferred forms thereof. Modifications may be made thereto without departing from the scope of the invention as defined by the accompanying claims.

1. A method of processing or modifying individual data files for transmission over a data network, the method executed by a processor of an electronic device, the method comprising:
retrieving, receiving, or accessing the individual data files to be transmitted;
processing the individual data files to determine the size of each individual data file;
comparing the individual data file sizes to a predetermined or calculated optimal data file size for transmission to identify non-optimally sized data files;
modifying one or more of the identified non-optimally sized individual data files based on the size comparison to generate modified individual data file sizes that match approximately the optimal data file size by selectively:
combining or merging individual data files that are smaller than the optimal data file size into a larger data file that is closer to the optimal data file size, and
splitting or segmenting individual data files that are larger than the optimal data file size into smaller data files that are closer to the optimal data file size; and
outputting the modified individual data files ready for transmission by the electronic device.

2. A method according to claim 1 further comprising identifying the file structure associated with the individual data files.

3. A method according to claim 2 wherein identifying the file structure of the individual data files comprises identifying the individual data files as being individual data files that form part of a data file package or batch for transmission, or identifying the individual data files as being contained within a single consolidated data file.

4. A method according to claim 2 wherein the processing of the individual data files to determine the size of each individual data file is based on the identified file structure of the individual data files.

5. A method according to claim 1 wherein the individual data files form part of a data file package or batch for transmission.

6. A method according to claim 1 wherein the individual data files are contained within a single consolidated data file.

7. A method according to claim 6 wherein processing the individual data files to determine each individual data file size comprises identifying the individual data file offsets within the single consolidated data file.

8. A method according to claim 1 wherein comparing the individual data file sizes to the optimal data file size comprises determining if the individual data file is larger, smaller, or approximately the same as the optimal data file size.

9. A method according to claim 8 comprising designating an individual data file as being larger than the optimal data file size if it is greater than a predetermined threshold above the optimal data file size.

10. A method according to claim 8 comprising designating an individual data file as being smaller than the optimal data file size if it is smaller than a predetermined threshold below the optimal data file size.

11. A method according to claim 8 comprising designating an individual data file as being the same as the optimal data file size if its size falls within a predetermined range centered about or relative to the optimal data file size.

12. A method according to claim 1 wherein when individual data files are split or segmented into smaller data files the method further comprises creating or generating an index file for transmission with the data files that records or stores the relationship of the segmented or split individual data files to enable re-assembly or re-combining back into the original data files after transmission.

13. A method according to claim 1 comprising leaving any individual data files that are the same as the optimal data file size unmodified.

14. A method according to claim 1 comprising modifying all identified non-optimally sized data files.

15.-16. (canceled)

17. A method according to claim 1 further comprising determining or calculating an optimal data file size for transmission over the data network.

18. A method according to claim 17 wherein determining or calculating the optimal data file size is based on or is a function of data representing any one or more of the following: data network capacity, data network speed, protocol of transmission, performance characteristics of transmitting and/or receiving electronic device, and/or specifications or characteristics of one or more of the hardware devices in the intended transmission path.

19. A method according to claim 17 wherein the optimal data file size for transmission is a value selected or derived from the function 2ⁿ kilobytes, where n is an integer value greater than or equal to eight.

20. A method according to claim 19 comprising selecting the integer value of n based on or as a function of data representing any one or more of the following: data network capacity, data network speed, protocol of transmission, performance characteristics of transmitting and/or receiving electronic device, and/or specifications or characteristics of one or more of the hardware devices in the intended transmission path.

21. A method according to claim 1 wherein the electronic device is a data or network server, wherein the electronic device is any one of the following: personal computer, tablet, smart phone, smart television, tablet, or wearable electronic device.

22. (canceled)

23. A method according to claim 1 further comprising streaming the processed individual data files over the data network in a single thread, or a plurality or multiple threads, and wherein the data files are audio or video data files for streaming.

24.-26. (canceled)
